(19) United States
(12) Patent Application Publication
(10) Pub. No.: US 2013/0113457 A1
(43) Pub. Date: May 9, 2013

(54) METHOD OF SENSING GENERATOR SPEED

(71) Applicants: Eric D. Albsmeier, Sheboygan, WI (US); Isaac S. Frampton, Strattanville, PA (US); Kenneth R. Bornemann, Cato, WI (US); Gary Allen Kroll, Sheboygan, WI (US); Douglas W. Dorn, Sheboygan Falls, WI (US)

(72) Inventors: Eric D. Albsmeier, Sheboygan, WI (US); Isaac S. Frampton, Strattanville, PA (US); Kenneth R. Bornemann, Cato, WI (US); Gary Allen Kroll, Sheboygan, WI (US); Douglas W. Dorn, Sheboygan Falls, WI (US)

(73) Assignee: Kohler Co., Kohler, WI (US)

(21) Appl. No.: 13/289,524

(22) Filed: Nov. 4, 2011

(51) Int. Cl. G01N 27/00

(52) U.S. Cl. 324/71.1

(57) ABSTRACT

Some embodiments relate to a method of sensing generator speed. The method includes detecting an AC waveform produced by a generator and determining a threshold voltage from the AC waveform produced by the generator. The method further includes determining generator speed by comparing the threshold voltage with the AC waveform. The generator speed may be determined by a time period between cycles of an output of the generator. Other example embodiments relate to a method that includes detecting an AC waveform produced by an alternative stator winding within the generator and measuring the period of the AC waveform to inversely determine generator speed.

### TECHNICAL FIELD

Embodiments pertain to a method of sensing generator speed, and more particularly to a method of sensing generator speed using amplitude threshold detection.

### BACKGROUND

Sensing generator frequency is commonly done in order to determine if the generator is operating within normal parameters. The frequency of an AC waveform produced by a generator is typically determined by measuring the elapsed time between zero crossings of the AC waveform.

One of drawbacks with measuring the elapsed time between zero crossings of the AC waveform is that with a low signal to noise ratio, phantom zero crossing may be undesirably detected resulting in potentially incorrect frequency measurement. This problem arises only at low voltage amplitudes which is not a typical operating condition of a generator.

These problems do not occur at higher levels because there is a high signal to noise ratio. Therefore, the noise does not cause the signal to inadvertently pass the zero crossing.

### BRIEF DESCRIPTION OF THE DRAWINGS

FIG. 1 is an example wave form plot that illustrates basic threshold detection.

FIG. 2 is an example schematic illustrating implementation of basic threshold detection.

FIG. 3 is a partial section view of an example alternator showing winding locations.

FIG. 4 is a block diagram that illustrates a diagrammatic representation of a machine in the example form of a computer system 400 within which a set of instructions for causing the machine to perform any one or more of the methodologies discussed herein may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

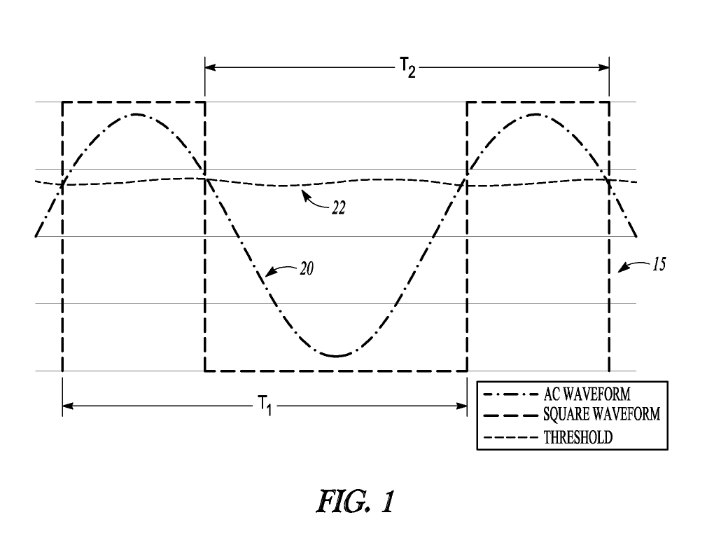

An example method of sensing generator speed will now be described with reference to FIGS. 1-3. In one example embodiment, the method includes detecting an AC waveform 20 produced by a generator (not shown) and determining a threshold voltage 22 from the AC waveform 20 produced by the generator. The method further includes determining generator speed by comparing timing of the threshold voltage 22 with the AC waveform 20.

It should be noted that the generator speed may be determined by a time period between cycles of an output of the generator. With reference to FIG. 1, the speed is determined using the equation:

generator speed=1/T1; or 1/T2 (1)

In some embodiments, detecting an AC waveform 20 produced by a generator includes scaling the voltage through a resistor divider network 25 to signal voltage levels. As an example, a differential amplifier 27 may be used to scale an unreferenced AC waveform 20 to a lower DC-referenced level 26.

Embodiments are also contemplated where determining a threshold voltage 22 from the AC waveform 20 produced by the generator includes determining an average rectified AC voltage. As an example, the full-wave-rectified AC signal 29 may be scaled using a differential amplifier 28 to a lower DC-referenced level 31.

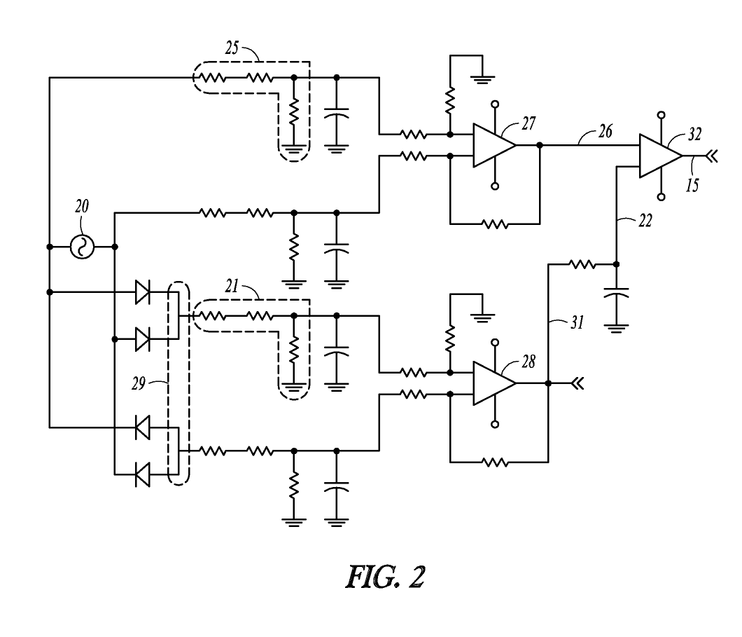

It should be noted that determining generator speed by comparing the threshold voltage 22 with the AC waveform 20 includes measuring the amount of time T betweens instances of the AC waveform 20 exceeding the threshold voltage 22. As examples, determining generator speed by comparing the threshold voltage 22 with the AC waveform 20 may include measuring the amount of time T betweens instances of the average AC voltage (i) dropping below the threshold voltage 22; or (ii) exceeding the threshold voltage 22. As shown in FIG. 2, the scaled DC-referenced level 26 of the AC waveform 20 is compared to the scaled DC-referenced level 31 of the full-wave-rectified AC signal 29 using comparator 32 to establish a square wave output 15 useful for determining generator speed.

In some embodiments, detecting an AC waveform 20 produced by a generator may include detecting an AC waveform 20 produced by an alternative stator winding 40 within the generator.

Another example method of sensing generator speed will now be described with reference to FIGS. 1-3. In one example embodiment, the method includes detecting an AC waveform 50 produced by an alternative stator winding 40 within the generator. The method further includes measuring a frequency of the AC waveform 50 to determine generator speed.

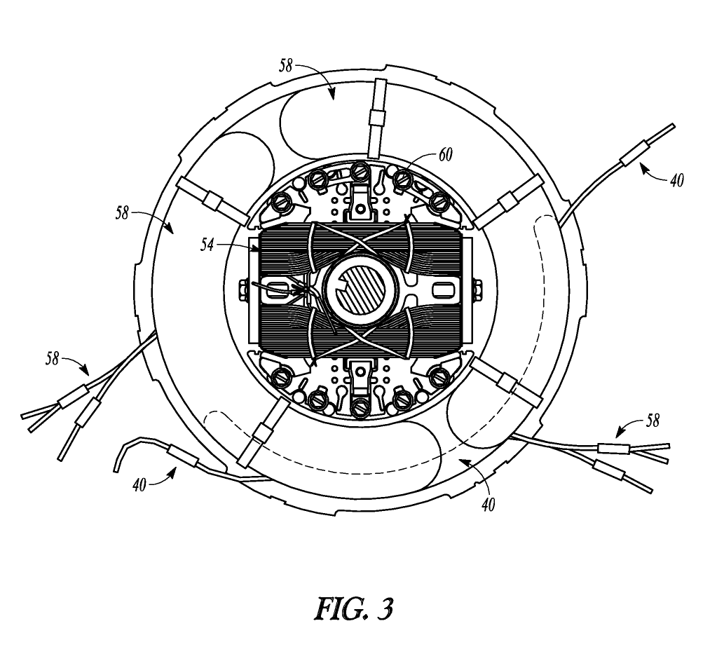

Sensing generator speed based on the AC waveform 20 produced by an alternative stator winding 40 may be beneficial since the voltage on a correctly phased alternative stator winding 40 will not collapse under a short circuit condition of the AC output of the generator which is produced by the main stator winding 58 (see FIG. 3). The ability to sense generator speed while the main AC output is short circuited may permit extended sourcing of current to the fault. Extended sourcing of current to the fault may allow downstream over current protection to isolate the fault.

In some embodiments, detecting an AC waveform 20 produced by an alternative stator winding 40 may include detecting an AC waveform 20 that is produced by an auxiliary winding that provides energy to excite an alternator field 54. It should be noted the auxiliary winding may be placed out of phase with the main winding 58 which provides the AC output of the generator.

Changing the phase between the auxiliary winding and the main winding 58 may allow (i) the excitation control system to continue to source current to the alternator field 54; and (ii) continued sensing of the generator speed.

Note that generator speed is related to rotor 60 speed by a ratio, as the rotation of the rotor 60 provides the AC frequency. Varying the number of magnetic poles on the rotor 60 will change the ratio between the rotor speed and the AC frequency. As an example, FIG. 3 depicts a 2-pole rotor, although other embodiments are contemplated where there is different than 2 rotor poles.

In other embodiments, detecting an AC waveform produced by an alternative stator winding 40 includes detecting an AC waveform that is produced by a stator winding that only performs speed sensing. As long as the alternative stator winding 40 is out of phase with the main winding 58, the voltage sensed from the alternative stator winding 40 will not collapse in a short circuit condition.

As shown in FIGS. 1-3, embodiments are contemplated where measuring a frequency of the AC waveform 20 to determine generator speed may include (as discussed above) (i) detecting an AC waveform 20 produced by the generator; (ii) determining an average AC voltage 29 from the AC waveform 20 produced by the generator to establish a threshold voltage 22; and (iii) determining generator speed by comparing the threshold voltage 22 with the AC waveform 20.

The method of sensing generator speed described herein may reduce the problems associated with measuring frequency having a low signal to noise ratio where phantom zero crossings might otherwise be undesirably detected to cause potentially incorrect frequency measurement. Therefore, the method of sensing generator speed may permit accurate frequency measurement at low voltage amplitudes which is not a typical operating condition of a generator.

### Example Machine Architecture

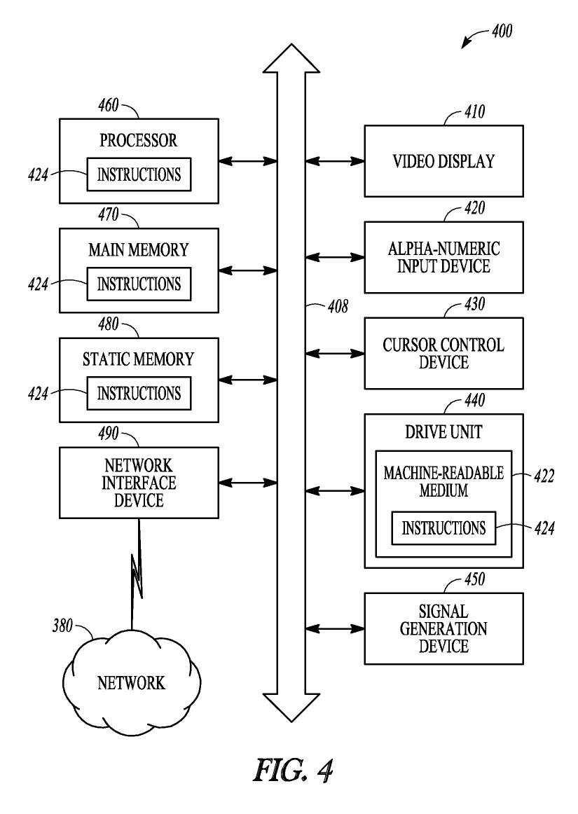

FIG. 4 is a block diagram that illustrates a diagrammatic representation of a machine in the example form of a computer system 400 within which a set of instructions for causing the machine to perform any one or more of the methodologies discussed herein may be executed. In some embodiments, the computer system 400 may operate in the capacity of a server or a client machine in a server-client network environment, or as a peer machine in a peer-to-peer (or distributed) network environment.

The computer system 400 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 may include a processor 460 (e.g., a central processing unit (CPU), a graphics processing unit (GPU) or both), a main memory 470 and a static memory 480, all of which communicate with each other via a bus 408. The computer system 400 may further include a video display unit 410 (e.g., liquid crystal displays (LCD) or cathode ray tube (CRT)). The computer system 400 also may include an alphanumeric input device 420 (e.g., a keyboard), a cursor control device 430 (e.g., a mouse), a disk drive unit 440, a signal generation device 450 (e.g., a speaker), and a network interface device 490.

The disk drive unit 440 may include a machine-readable medium 422 on which is stored one or more sets of instructions (e.g., software 424) embodying any one or more of the methodologies or functions described herein. The software 424 may also reside, completely or at least partially, within the main memory 470 and/or within the processor 460 during execution thereof by the computer system 400, the main memory 470 and the processor 460 also constituting machine-readable media. It should be noted that the software 424 may further be transmitted or received over a network (e.g., network 380 in FIG. 3) via the network interface device 490.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of example embodiments described herein. The term “machine-readable medium” shall accordingly be taken to include, but not be limited to, solid-state memories and optical and magnetic media.

Thus, a computerized method and system are described herein. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of sensing generator speed comprising:
detecting an AC waveform produced by a generator;
determining a threshold voltage from the AC waveform produced by the generator; and
determining generator speed by comparing the threshold voltage with the AC waveform.

2. The method of claim 1, wherein detecting an AC waveform produced by a generator includes scaling the voltage through a resistor divider network to signal voltage levels.

3. The method of claim 1, wherein determining a threshold voltage from the AC waveform produced by the generator includes determining an average rectified AC voltage.

4. The method of claim 1, wherein determining generator speed by comparing the threshold voltage with the AC waveform includes measuring the amount of time betweens instances of the average AC voltage exceeding the threshold voltage.

5. The method of claim 1, wherein determining generator speed by comparing the threshold voltage with the AC waveform includes measuring the amount of time betweens instances of the average AC voltage dropping below the threshold voltage.

6. The method of claim 1, wherein detecting an AC waveform produced by a generator includes detecting an AC waveform produced by an alternative stator winding within the generator.

7. A method of sensing generator speed comprising:
detecting an AC waveform produced by an alternative stator winding within the generator; and
measuring a frequency of the AC waveform to determine generator speed.

8. The method of claim 7, wherein detecting an AC waveform produced by an alternative stator winding includes detecting an AC waveform produced by an auxiliary winding that provides energy to excite an alternator field.

9. The method of claim 7, wherein detecting an AC waveform produced by an alternative stator winding includes detecting an AC waveform produced by a stator winding that only performs speed sensing.

10. The method of claim 7, wherein measuring a frequency of the AC waveform to determine generator speed includes:
detecting an AC waveform produced by a generator;
determining an average AC voltage from the AC waveform produced by the generator to establish a threshold voltage; and
determining generator speed by comparing the threshold voltage with the AC waveform.
